(19) United States
(12) Patent Application Publication
(10) Pub. No.: US 2009/0240554 A1
(43) Pub. Date: Sep. 24, 2009

(54) SYSTEM AND METHOD FOR PROVIDING IDENTIFICATION AND LOCATION INFORMATION OF CERTAIN ITEMS

(75) Inventors: James T. Oswald, Clemson, SC (US); Taji Richardson, Greenville, SC (US)

Correspondence Address: MCNAIR LAW FIRM, P.A., P.O. BOX 447, GREENVILLE, SC, 29602-0447, US

(73) Assignee: PinPoint GeoTech, LLC, Clemson, SC (US)

(21) Appl. No.: 12/410,292

(22) Filed: Mar. 24, 2009

Related U.S. Application Data
(60) Provisional application No. 61/038,995, filed on Mar. 24, 2008.

(51) Int. Cl. G06Q 10/00; G06F 17/00; H04N 5/225; G06F 17/30; G01S 1/00; G01C 21/00

(52) U.S. Cl. 705/9; 700/94; 348/207.1; 707/3; 342/357.09; 701/209; 348/E05.024; 707/E17.001

(57) ABSTRACT

A system and method for recording the identification and location of items in furtherance of maintaining public works infrastructure includes a portable computing device in communication with a server unit. A user selects designated icons visually representing a variety of items needing attention by a local public works department, such as discarded appliances, brush piles, downed power lines, or code violations. The portable computing device stores the type and location of these items electronically for transfer to the server unit, where work orders may be issued to appropriate employees to later address the items in a coordinated manner rather than merely addressing these items as they are randomly encountered during a normal public works route.

### CLAIM OF PRIORITY

This application claims priority from U.S. Provisional Patent Application Ser. No. 61/0038,995 entitled System and Method For Providing Identification and Location Information of Certain Items filed Mar. 24, 2008.

### FIELD OF THE INVENTION

This invention is directed to a system and method of identifying and marking the physical location of items encountered during a work route that generally require some follow-up attention by public works employees.

### BACKGROUND OF THE INVENTION

Today's society is dependent upon public infrastructure to provide services such as electricity, roads, water, sewer, garbage collection, and the like. In an effort to provide better support for the public infrastructure as well as to reduce the costs of supporting the public infrastructure, companies that provide infrastructure support establish policies, schedules, and regulations for citizens to follow. For example, garbage pick-up services occur on set schedules and citizens are informed when to place garbage containers for curb-side pick-up.

While general household refuse can be placed in garbage containers for pick-up, larger or bulkier items such as refrigerators, furniture, hot water heaters, and the like are much more difficult to handle and generally not included in the day-to-day household refuse service. Garbage collection service providers generally have policies concerning how citizens can notify the service provider for picking up these out-of-the-ordinary items. Unfortunately, some citizens do not follow those policies and simply leave refrigerators, furniture and other bulky items lying beside roads, or worse, in vacant lots where they tend to collect into improper garbage heaps.

In order for these out-of-the-ordinary items to be disposed of, the garbage service provider must first know the location of the item and the type of item. Currently, refuse truck operators try to record the location and type of such refuse while on normal garbage pick-up routes so that the out-of-the-ordinary refuse can be subsequently collected by the appropriate truck and crew. Garbage truck operators generally use the radio or a notepad to record the location and type of these items. This method is not often an effective or efficient methodology for handling this type of refuse. Notes can be lost, the location can be misidentified, and radio communications can be misunderstood. When operators use hand-writing to record the location of special debris pickup locations, problems exist that include inaccurate transfer of information, excessive administrative processing, and delay in collection of special debris. These inefficiencies can lead to a roadside hazard so that it would be advantageous to retrieve these items as quickly as possible. Further, there is no present centralized method for collecting item locations or item type; notes can be lost, the location can be misidentified, and radio communications can be misunderstood.

The current method of handling out-of-the-ordinary items is also inefficient and harmful to the environment since it involves periodic and random patrolling of every city street by heavy loading and hauling equipment in the hopes of randomly locating these items. This extensive patrolling incurs high labor, fuel, and other equipment costs, and results in excessive wear and tear on road surfaces, as well as excessive and hazardous presence of heavy equipment in residential areas. Adverse environmental effects also result from the excessive carbon emissions from the extensive equipment operation.

Another problem that exists in the garbage pick-up service industry is that certain citizens are unable to move their garbage containers to the curb for pick-up on garbage day. This inability of the citizen can be due to an illness, age, or handicap. Often in these cases garbage collectors must leave the refuse truck in order to retrieve the garbage container from the citizen's property for citizens that meet such criteria. In practice, the garbage truck operator can identify these citizens with special service needs through a marking on the curb in front of the citizen's property. For example, the curb at the driveway may be painted with a blue square or the mailbox may have a particular dot or some other physical marking to inform the operator of the special services required for the citizen. It is difficult to update all addresses under this method because citizens may move or the need for special services may end without notification of the refuse collectors. As a practical result, the refuse truck operator generally has no way of knowing the change in status unless the physical marking from the property is removed. A system and method for providing a refuse truck operator with any special service needs of a citizen that is not reliant upon physically marking the property would provide advantages over existing methodologies.

Another problem with servicing public infrastructure is general maintenance and repair. For example, even with the majority of power cables buried underground, there are still over 100 million utility poles in the United States. These poles and other electrical equipment often need repair and, unless properly maintained, can cause significant damage to property and serious injury to citizens. Roadways are also significant components of public infrastructure that are generally in need of constant repair. Items such as potholes and damaged guardrails create dangers that can result in serious bodily injury and death. It is therefore critical that public infrastructure be routinely maintained so that repairs are made prior to any problems becoming severe enough to be a danger to the community.

Traditionally, public infrastructure service providers inspect infrastructure by periodically driving around communities looking for items such as potholes, broken street lamps, damaged utility poles, and the like. As repair crews travel to and from specific repair sites, they often come across other items of public infrastructure that need repair or other attention by the proper public service personnel. If there is time or inclination, these service providers or operators may record the location and a brief description, usually by paper, and continue on to the scheduled location. It would be advantageous to have a system and method for identifying these additionally located public infrastructure items so that repairs or other appropriate action can be scheduled and subsequently made. Moreover, it would be advantageous to have a system and method for allowing public infrastructure service providers that have personnel or operators in the field to mark items noted during the normal course of their duties around a community. Once located and marked, these items can be addressed more quickly, thereby increasing efficiency, improving safety, and saving time and money for repair of public infrastructure.

An additional problem with the current method of identifying items needing attention is that there is no centralized automated system or method for managing the work flow process from identification of the item needing attention and its location, generating a work order for the item, scheduling a crew to attend to the item, determining whether the item issues have been resolved, and marking the work order when completed so that the work order can be closed. It would be advantageous to have a system and method that would manage the steps identified above in a centralized integrated manner.

Another area of concern is the enforcement of rules, regulations, and codes related to public infrastructure. In the maintenance of public infrastructure, regulations and policies exist to help ensure that citizens understand the rules and regulations that are put in place by local, city, county, state or federal agencies. These rules and regulations serve several purposes. First, they allow for the public infrastructure to be better managed and controlled by public infrastructure service providers. For example, businesses are issued permits for various items that are associated with health, safety, competency, and use of public infrastructure. Additionally, there are codes that are to be followed for business and private citizens alike. For example, many municipalities have codes that prohibit excessive litter, maintaining certain structures in disrepair, and keeping vegetation over a predetermined height. Municipalities generally have code enforcement divisions who enforce these codes and can issue citations and fines for code violations. Typically, code enforcement personnel patrol a certain jurisdiction and inspect property or respond to complaints from the community. When an enforcement officer discovers a violation, the enforcement officer needs to record the violation, which includes recording the violation type and location of the violation. Additionally, the owner of the premises where the violation occurred must also be recorded to ensure that the citation or warning is issued to the proper entity. In some cases, this can be problematic.

For example, when inspecting the back of a building that has multiple store fronts, if may be difficult to determine which store the violation should be associated with. Typically, the enforcement officer counts from the end of the building the number of doors or other identifiers to determine the address by the number of stores from the end. The enforcement officer then must go to the front of the building and again count down that number of stores to determine the violator. This process has much of the same inefficiencies and is prone to the same errors that are experienced with other public infrastructure service organizations such as refuse collection companies. Therefore, it would be advantageous to have a system and method that allowed an enforcement officer to record a violation, including violation type and location, without resulting to simply hand-written forms and counting stores.

Another area where centralized item identification and location recordation could be advantageous is in management of work after a man-made or natural disaster. Historically, areas affected by disasters have multiple issues that need identification and resolution. Such issues include damaged public infrastructure, refuse collection needs, demolition and constructions needs, citizen evaluation, medical care, and the like. Further, typical physical and geographic identification methods may not be effective since post-disaster locations can be missing street signs, directional signs, and even roads. The clean-up process post disaster results in many individuals traveling through the disaster for various tasks. It would be advantageous if these individuals could use a system and method for recording tasks or items that require attention along with the location.

Another potential problem can be found in hazardous materials and man-made disasters such as biological, chemical or nuclear attacks. In those instances, it would be advantageous to have a system that allows for additional peripherals to provide additional warnings to workers in the aftermath of such an attack. For example, a radiation detection unit could be configured to send radiation alerts to the individual users for location and mapping of nuclear hotspots. The same would be useful for biological and chemical hotspots.

Further, none of the situations above that require the identification of an item and its location have centralized repositories for the collected information. Therefore, efficient organization of information, generation of work orders and tasking of service providers can not be optimized since there is no central place for recording items and locations that need attention and creating work order and work routes that can be used for scheduling appropriate remedial action for the items identified. Additionally, without a centralized system, it is significantly less efficient to manage the ability to determine when an identified item has been attended to. Further, service providers who attend to the identified items generally have to return to a home office or other location to receive work order information in order to attend to the identified items.

Accordingly, an object of the invention is to provide a system and method that allows operators for public infrastructure providers and others to identify and mark the location of action items so that the items can be scheduled for subsequent attention.

Another object of the invention is to provide for a system and method for automated and centralized work management for items.

Another object of this invention is to provide for a system and method for managing the remediation process for identified items from the initial identification of the item to the remediation of the item.

Another object of the invention is to reduce emissions and fuel consumption of public service vehicles by lowering the need for use of such vehicles.

### SUMMARY OF THE INVENTION

The above objectives can be accomplished by providing a system for identifying and recording items of interest comprising a portable computing device having a GPS receiver, display and portable computer storage media in communications with a server; a portable device program embodied in said computer storage media of said portable computing device that when executed by said portable computing device performs the steps of displaying item data wherein said item data represents items of interest, receiving user input representing that an item of interest has been identified by the user, generating a record representing the item of interest using said user input, retrieving location information from said GPS receiver, including said location information in said record, retrieving temporal information from said portable computing device, including said temporal information in said record, storing said record in said portable computing device; and, a server program embodied in said server that when executed by said server performs the steps of receiving said record, generating a map displaying an icon representing said item of interest according to said record and transmitting said map display to said portable computing device so that said portable computing device can display said map display allowing the user to view the location of the item of interest and its location.

The invention can also include a microphone included with said portable computer device; and, said portable device program performs the steps of receiving audio information from said user representing verbal information about the item of interest and associating said audio information with said record.

The invention can also include a camera included with said portable computing device; and, said portable device program performs the steps of receiving visual information from said user representing images about the item of interest and associating said visual information with said record.

The server program can include the steps of receiving a plurality of records, receiving filtering criteria from said user, generating said map display according to said filtering criteria having a plurality of icons representing a plurality of items of interest so that said map display provides only items of interests according to said filtering criteria and receiving a plurality of records, determining a route between said items of interest represented by said icons according to said records, generating said map display according to said having a plurality of icons representing a plurality of items of interest, and indicating the order of travel between said items of interest according to said determined route.

The invention can include a set of crew information included on said server representing workers, worker's skills, worker's work schedules and worker's routes; said server program performs the steps of generating a work order according to said records and said set of crew information, transmitting said work order representing task to be preformed by a worker to said portable computing device, receiving completion information representing that the worker has satisfied the tasks described in said work order and associating said completion information with said work order; and, said portable device program includes the steps of receiving said work order, displaying said work order on said portable computing device display, receiving completion information from the user of said portable computing device and transmitting said completion information associated with said work order to said server so that the user of said server is informed that said work order has been completed.

The invention can include a GPS server in communication with said server; a set of physical address information indexed by GPS coordinates stored on said GPS server; and, said server performs the steps of retrieving physical address information from said GPS server according to GPS coordinates included in said location information of said record and transmitting said physical address information to said portable computing device. Physical addresses can be retrieved that are in proximity to the GPS coordinates.

The invention can include a set of profiles included in said portable computing device wherein each profile contains a set of icons representing items of interest; and, said portable device program includes the steps of retrieving a profile from said set of profiles and retrieving icons from said profile so that said icons can be displayed on said portable computing device.

The invention can include a set of code regulations stored on said portable computing device; and, said portable device program performs the steps of displaying a list of code regulations on said display, receiving code violation information from the user representing the code regulation selected by the user, associating said code violation information with said location information to that said code violation can be associated with a location.

### DESCRIPTION OF THE DRAWINGS

The construction and steps designed to carry out the invention will be described hereinafter, together with other features thereof. Hence the invention will be more readily understood from a reading of the following specification and by reference to the accompanying drawings forming a part thereof, wherein an example of the invention is shown and wherein:

FIG. 1 is a perspective view of a system for marking and mapping items according to a preferred embodiment of the invention;

FIG. 2A is an illustration of a screen display of the invention;

FIG. 2B is an illustration of a screen display of the invention;

FIG. 2C is an illustration of a screen display of the invention;

FIG. 2D is an illustration of a screen display of the invention; and,

FIG. 2E is an illustration of a screen display of the invention

FIG. 3 is a block diagram view of some of the components of the invention;

FIG. 4 is a flow chart indicating steps of the invention; and

FIG. 5 is a flow chart indicating steps of the invention.

### DETAILED DESCRIPTION

An object or module is a section of computer readable code embodied in a computer readable medium. The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result. These steps require physical manipulations of physical quantities such as electrical or magnetic signals capable of being stored, transferred, combined, compared, or otherwise manipulated readable medium that is designed to perform a specific task or tasks. Actual computer or executable code or computer readable code may not be contained within one file or one storage medium, but may span several computers or storage mediums. The term “host” and “server” may be hardware, software, or combination of hardware and software that provides the functionality described herein.

The present invention is described below with reference to flowchart illustrations of methods, apparatus (“systems”) and computer program products according to the invention. It will be understood that each block of a flowchart illustration can be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks.

These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks. Computer program instructions may also be loaded onto a computer or other programmable apparatus to produce a computer executed process such that the instructions are executed on the computer or other programmable apparatus provide steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions. The present invention is now described more fully herein with reference to the drawings in which the preferred embodiment of the invention is shown. This invention may, however, be embodied any many different forms and should not be construed as limited to the embodiment set forth herein. Rather, these embodiments are provided so that this disclosure will be thorough and complete and will fully convey the scope of the invention to those skilled in the art.

In one embodiment, this invention can be used for recording the identification and location of items of interest in furtherance of maintaining public works infrastructure. An item of interest is therefore anything that might be identified that needs subsequent attention. For example, items of interest can include: discarded piles of yard waste or debris, discarded furniture or appliances that need to subsequently be removed from their present location, and utility equipment and infrastructure that is in need of repair such as potholes, non-functional street lights, and the like. When employed, the invention uses a portable computing device to mark the location of items of interest. Information gathered and stored on the portable computing device can be transmitted to a server for centralized storage and management.

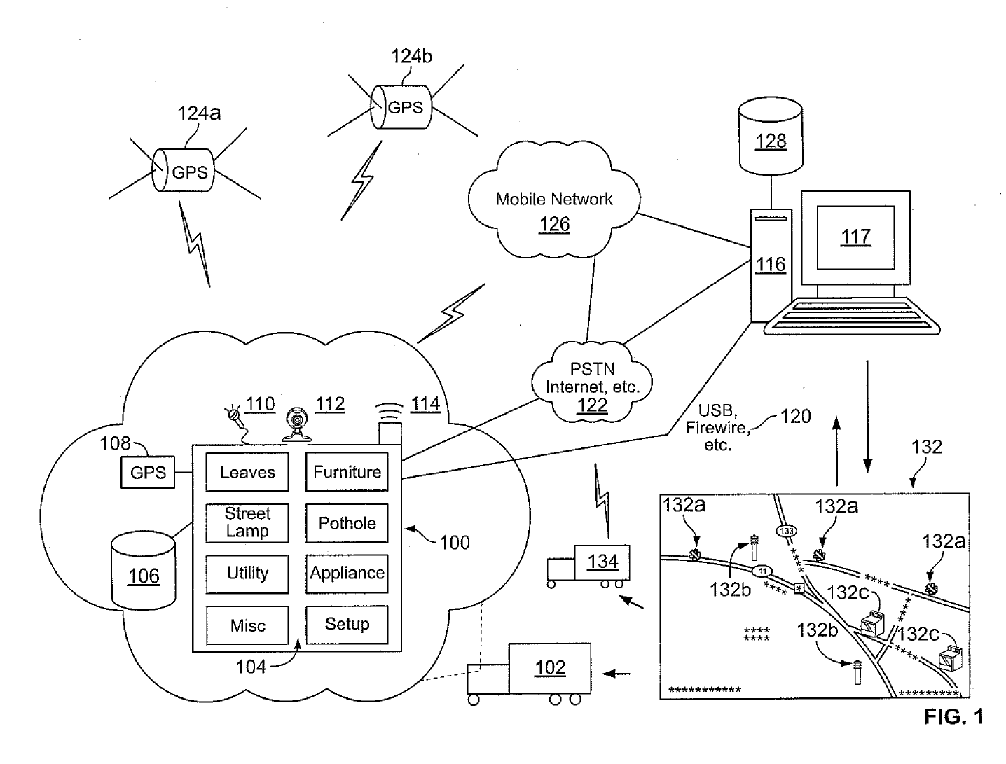

As seen in FIG. 1, portable computing device 100 can be included in a public infrastructure support vehicle 102. By way of example and not limitation, such vehicles can include garbage trucks, sewage system repair trucks, and electrical system repair trucks. Computer readable instructions are provided within portable computing device 100 and stored on computer readable medium 106 and, when executed by a processor, can direct the operation of the portable computing device. The computer readable instructions on the portable computing device, also known as the portable device program, are available to provide information to and receive input from the user that can also be the operator of the public infrastructure vehicle. The portable computing device 100 can be integrated into the vehicle 102, an aftermarket addition to the vehicle, or a portable unit that is simply carried by the vehicle operator or a passenger.

Multiple profiles can be configured and selected by users of the invention. A profile is a set of predetermined selectable icons that are available to a user of the portable computing device and generally tailored for a particular user application. The icons represent items of interest or control buttons for navigation and input to device 100. For example, in one embodiment, a profile is tailored for refuse collection. As such, icons included in the profile might be leaves, furniture, appliances, bags and other such refuse items. The portable computing device 100 displays these icons representing items of interest and allows the user simply to select the proper icon when the item of interest is discovered on the route. Another example of a profile, particularly for road maintenance, can include icons for potholes, guardrails, signs, road debris, or the like. Another example of a profile, such as post-disaster applications, can include icons that represent a live electrical wire, unstable structure, open sewer, unusable roadway, damaged bridge, or the like. Another example of a profile, particularly for code enforcement, can include litter on a property, abandoned vehicles, unlicensed vehicles, excessive foliage, or the like.

When a specific type of item is identified by the vehicle driver, also known as the operator, the driver can select the appropriate icon on the touch screen 104 of portable computing device 100. In this embodiment, users are generally allowed to configure in advance 2, 4, 6, or 9 buttons on touch screen 104, depending upon the user preferences and needs. In refuse collection, for example, the profile allows a touch screen to include a variety of icons related to the items of interest for refuse normally encountered during a daily route. Once the user selects an icon on the portable computing device, a record is created in the portable computing device's computer readable memory 106. Information that can be included in various item type fields of the record includes, among other things, location, type, audio, video, pictures, speed, heading, the number of GPS satellites, GPS precision, parcel ID, and an address either automatically selected, hand-picked, or manually entered by the user.

At the moment the user selects the appropriate icon, the portable computing device begins to populate the record by saving the item type along with the GPS coordinates. The GPS information generally populates the location fields of the record by gathering GPS information from GPS receiver 108, which is in communication with a plurality of GPS satellites 124a and 124b, to allow GPS receiver 108 to precisely pinpoint the physical location of portable computing device 100. In a preferred embodiment, the GPS information stored includes latitude, longitude, number of satellites used to triangulate the position, PDoP (which stands for Position Dilution of Precision, a GPS precision indicator), speed, date and time (received in universal time format). This information is sometimes collectively referred to as location information, but generally location information is referred to herein as latitude and longitude. Other information can also be recorded in the record such as date and time that is generally stored with location data but may optionally be taken from the internal system of portable computing device 100. Moreover, temporal information is preferably saved in each record.

The operator can add additional information to the record, such as audio information describing the located item or visual information such as an image of the located item and its surroundings. The driver can use microphone 110 to record audio information that is then associated with the record. The operator is preferably given the option to re-record the voice note, save it, or cancel the voice note operation. The operator can also use camera 112 to record images of the item and that corresponding visual information is then associated with the record on computer readable medium 106. Visual information generally comprises still pictures and video but it can also include audio. This audio information and visual information are then recorded along with the record and stored in the portable computing device's computer readable medium 106.

It is also possible to add peripherals to the portable computing device, such as a portable belt-clip printer that could be added for printing in the field.

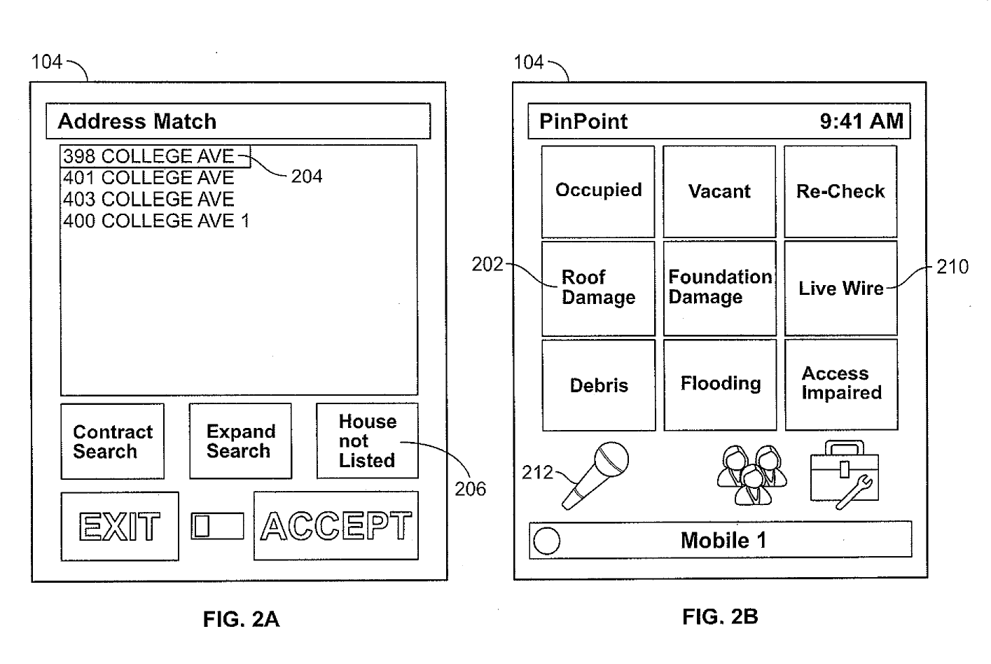

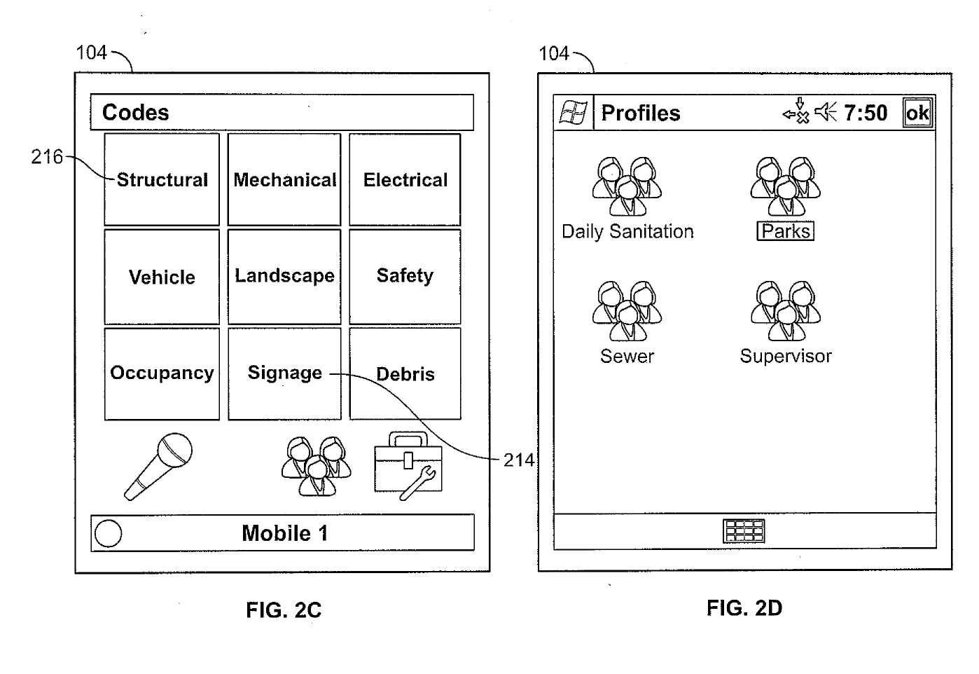

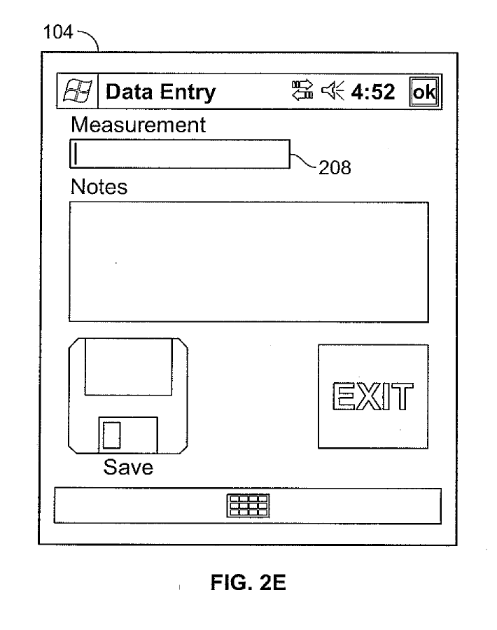

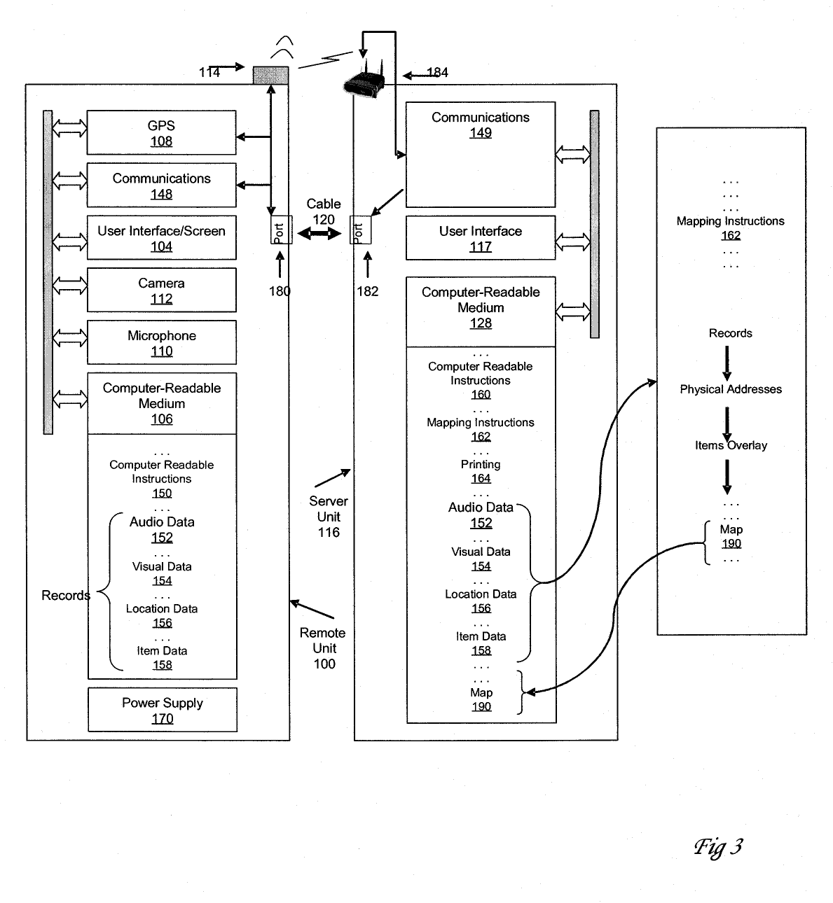

The portable computing device screen 104 may also be used for inputting form-driven information such as free-form text or numeric data. For instance, the operator may want to add roof damage information in the aftermath of a hurricane. In that case, the operator would select a specific profile to enter the post-disaster profile screen shown in FIG. 2B. The operator would then select icon 202 for Roof Damaged to enter a specific form for roof damage, which would then display an alphanumeric entry form on touch screen 104 that would allow the operator to type in the specific address, for example, where the damaged roof is located. In one embodiment shown in FIG. 2A, the computer readable instructions automatically insert the default address 204 calculated from GPS location information as compared to the saved address information in the portable computing device's computer readable medium 106. The operator then selects that address if correct or selects House Not Listed 206 to enter the free-form alphanumeric screen to manually enter the proper address. Once entered, this address is saved as the correct address with the record.

This feature would also be useful to a Department of Transportation assessor who might use the invention to locate and assess road grades on a roadway. As shown in FIG. 2E, the assessor could enter the data entry screen to enter raw measurement data and notes according to the road grades encountered during the inspection. In this way, the assessor would simply choose the location by pressing an item icon and then select a numeric value for the road grade in entry 208 to save road grade data with the record to indicate the road grade in that location.

In one embodiment, the operator would begin by selecting the proper profile to display the proper icons on touch screen 104. The operator would then select the proper icon to indicate the specific item located that is associated with that particular profile. In this example, the operator enters a typical post-disaster profile as shown in FIG. 2B. This profile displays nine individual item icons to indicate nine of the most common types of items one might encounter during post-disaster situations. If the operator discovered a live electrical wire during his route, as shown in FIG. 2B, the operator could select “Live Wire” icon 210 using touch screen 104. This would then cause the portable computing device to create a new record with the item type Live Wire. It would also cause the portable computing device to simultaneously retrieve the GPS coordinates from GPS receiver 108. Then both the item type and the GPS coordinates are saved as a new record in computer readable medium 106. If an icon for “Live Wire” were not available, the operator may instead select the microphone icon 212 or a Misc icon (not shown) to enter text, voice, picture, or other data to appropriately denote and record a record of the located item.

The operator would take a similar approach if he or she were, for example, a code enforcement inspector or compliance officer. Referring to FIG. 2C, the portable computing device screen 104 is shown with nine of the most common enforcement code icons. During a code compliance inspection, the operator might encounter a code violation that can be recorded and stored in a record. The operator would presumably be in the code enforcement profile and, if not, could enter that profile by selecting the appropriate icon upon startup of portable computing device 100 from touch screen 104.

Once in the proper profile, the operator may select an icon to record a located code violation such as an improper advertisement using icon 214 or improperly erected addition to a structure using icon 216. A set of code regulations is preferably stored in portable computing device 100 for retrieval and use by the operator. Portable device 100 displays the list of code violations on display 104, which then accepts user input to select the proper code violation. The selected code regulation is then associated with the record and stored in computer readable media 106. If additional information needs to be stored with the item, the operator need merely select the appropriate icon on touch screen 104 then enter appropriate additional data, such as audio or visual data to appropriately describe the violation noted. The operator may also have the ability to enter additional alphanumeric data in an Address Match screen such as shown in FIG. 2A to allow the operator to enter the correct address for the specific violator's location, rather than depend upon the map database information in computer readable medium 106, which might result in issuance of a code violation against the owner of an incorrect address.

Referring to FIG. 2D, four potential profiles are illustrated as individual icons. These four profiles are by way of illustration and not limitation. It should also be noted that profiles can be switched on portable computing device 100 so that a single portable computing device can be used to record item information based upon multiple profiles. Multiple profiles allow for the operator to address the different types of information encountered by a public works employee. This is also important because it provides one of the main benefits of the invention in that it allows a large and varied workforce to locate and record items needing attention during their daily routes, whether or not the items are related to the specific operator's duties. This is possible because the computer readable instructions contained on computer readable medium 106 can associate the profile selected with the record and can even contain additional fields for each record based upon the selected profile. Generally a set of profiles is stored in computer readable medium 106, along with a set of icons representing individual items of interest. Computer readable instructions in computer readable medium 106, also know as a portable device program, include steps for retrieving various profiles and icons from this set of profiles and icons for display on screen 104.

This feature of the invention is also useful, for example, in post-disaster applications, where a large variety of items needing attention may be encountered by a variety of public works and other personnel. As shown in FIG. 2E, additional data fields can be included in the invention and used to document the numerous items of interest that need attention when encountered by various personnel in the post-disaster situation. In the case of a live electrical wire, for example, a high priority can be assigned so that this particular item can be marked to receive the highest attention.

Similarly, in the case of hazardous materials involved with man-made disasters, such as biological, chemical or nuclear attacks, a radiation detection unit could be configured and connected to portable computing device 100 in order to send radiation alerts to the individual users for location and mapping of nuclear hotspots. In one embodiment, the radiation detector can be Bluetooth enabled and might connect to the portable computing device 100 through Bluetooth wireless connection. The same would be useful for identifying and marking biological and chemical hotspots.

Profiles can also be organized such that sub-profiles are displayed when a button is pressed. This allows the operator to branch several profiles from an existing profile. In one embodiment a post-disaster assessor may have a screen with several different types of infrastructure items. An icon on touch screen 104 labeled, for example, “Utility” may lead to another screen that has buttons for power, water, gas, or the like. Those icons may in turn open another screen with more specific categories relating to the parent category.

In one embodiment, this invention can be used for providing location specific information to the operator. For example, citizens with special needs can be better served by allowing a public service employee to input location specific information into the server's computer readable medium 128 or the portable computing device's computer readable medium 106. In the alternative, it is possible that the public works organization may choose to operate a web interface that allow citizens to logon to an individual account associated with the citizen's address to input special needs information. That special needs information could then be transferred to server computer readable medium 128 as a set of location specific information and then transferred to the portable device's computer readable medium 106.

When an operator is working on a route, for example, the computer readable instructions operate in conjunction with GPS receiver 108 to continually monitor the location of portable device 100 and cause portable device screen 104 to provide a continually updated location, such as the nearest address. These instructions are also continually monitoring the set of location specific information stored in computer readable medium 106. When portable computing device 100 is in proximity to a specific location for which location specific information is stored, these instructions cause device 100 to display a visual notification on screen 104 indicating that the operator should be aware of special instructions associated with that specific location. If, for example, a handicapped person resides at the home, the notification could inform the operator that the crew needs to go around to the back of the home to retrieve the garbage cans since the homeowner is not able to place the cans at the curb.

In one embodiment, an Internet website is provided to allow individual citizen users to logon to an account. This website would therefore include instructions to allow an individual citizen to register an ID and password for entry into the website. The ID would be associated with the citizen's specific address listed on the account. Once logged-on to the website, the citizen could navigate to a portion of the website entitled, for example, Special Instructions, where the citizen could enter information regarding special needs. This embodiment could also be useful to allow citizens to enter specifics regarding a vacation schedule or the presence of vicious animals.

Local agencies and companies could be selected or designated by the citizen in the website so as to allow certain agencies and companies to connect to the database associated with the website in order to retrieve sets of location specific information from user accounts that are then indexed by location information. In this way, a citizen could inform local agencies and companies of any special instructions associated with a specific location. That information would be useful to agencies and companies, such as garbage collectors, the U.S. post office, Federal Express, United Parcel Service, and the like, who could use the information to better direct operators on their daily routes. This information could, for example, alert police officers or postal workers as they approach homes that the occupants are on vacation or otherwise not presently occupying the home. By saving the special instructions on the website, citizens can even inform local police regarding the details of upcoming vacation plans. Police officers could check this information if the officer detects suspicious activity at a particular home or could use this information to simply check on the home during its patrol. At the same time, postal workers could be alerted to hold mail for the vacation period so as to avoid the appearance of an owner's absence.

As illustrated in FIG. 1, once one or more records are stored on portable computing device 100 in computer readable medium 106, those records can then be transferred to server 116, which includes a set of server computer readable instructions stored on computer readable medium 28. As such, server 116 can receive the records from portable computing device 100 that can then be stored in a server database. Server 116 can be located in a variety of places. It can be in, for example, a centralized location separate from the public infrastructure entities and in direct communication with a public works department, separate from the public infrastructure entities and not in direct communications with a public works department, or located at the public works department itself. A person of ordinary skill in the art would understand that the server can also be a virtual server comprised of computer readable instructions or a combination of software and hardware.

The transfer of records can also be accomplished using a variety of connection means, including USB ports on portable computing device 100 and server 116, wireless through mobile network 126, or wired through the public switched telephone network (PSTN) 122 using modems in portable computing device 100 and server 116. The transfer can also be in batch or real-time based upon user preference and connectivity.

Regardless of the connection means, once the connection is established, the records stored on computer readable medium 106 are then transferred to server 116 and stored in server computer readable medium 128. After records are transferred and stored, server computer readable instructions contained in computer readable medium 128 can also be used to convert the location data in each record into physical addresses. As discussed above, this can also be accomplished prior to transfer on portable computing device 100 using the computer readable instructions contained in computer readable medium 106. It can also be done a second time on server 116 after transfer using computer readable instructions contained in computer readable medium 128 to effectively verify the address indicated in the transferred record.

In one embodiment, geographic information system (GIS) data is compared against the GPS information from the record to determine physical address information. The system could be configured to download GIS shape files to show the general outline of the property and other properties in proximity to the area in question. For example, the parcel boundary layer can be downloaded from a GIS system. This shape can be compared by the operator in the field with the property as observed first hand. Or it could be compared by an operator using server 116 to compare the shape of the property with the operator's notes and other information stored with the record. It is also possible that the user could download aerial images of the area for further confirmation of the correct property. Physical address information can include a street address, ownership information, an aerial photograph, boundary lines, road centerlines, parcel information, tax information, and the like. This physical address information is generally stored as a set on server 116 in computer readable medium 128, but in another embodiment can also be stored as a set on portable device 100 in computer readable medium 106.

In one embodiment the operator can create a location item icon on portable computing device 100 that will open an address verification form on touch screen 104. This option opens a form that loads GIS information into a list. The address information shown is typically gathered from a city or county GIS department. The computer readable instructions contained in either or both of computer readable medium 106 and computer readable medium 128 can be used to search the addresses within an area around the current GPS point called a “bound box” and then load all of those addresses into the list. The bound box is a set of four GPS coordinates that can be expanded or contracted by 0.0002 GPS decimal degrees at a time. In one embodiment, the max size of the box is 0.0021 decimal degrees from the GPS point, while the minimum size is 0.00012 decimal degrees from the GPS point.

Operators can also manually add almost any of the data fields or points in the record to allow for discrepancies in the record. For example, any address that does not exist in the GIS table would have to be manually entered into the record. It would also be necessary to verify any addresses that were not properly entered into the GIS database or not automatically located by the computer readable instructions contained in either or both of computer readable medium 106 and computer readable medium 128.

Once the operator property identifies the address while in the field with portable computing device 100 or in the office with server 116, if necessary, the operator or user can then manually enter the latitude and longitude coordinates, property ID, and any other information pertinent to the record, such as the actual code a property owner has violated if the code enforcement profile is selected.

In another embodiment, GPS coordinates from the record can be used to determine the associated physical address using Microsoft's MapPoint or other similar software application. In the case of MapPoint, an algorithm is used that creates an ever-expanding circle around the location's GPS point until MapPoint recognizes the location as a valid address. The server 116 has server computer readable instructions that provide for a client application for the invention. The client computer readable instructions generally provide the interface between the user and the computer readable instructions of the server 116. It should be noted that the server computer readable instructions and the client computer readable instructions need not reside on the same computer readable medium, such as computer readable medium 128, and can use two different hardware systems in communication with each other to provide the functionality described herein.

The client computer readable instruction can then display the item in graphic form such as a map to show the addresses of the items identified. Because records often consist of many types of items, the client can also display an associated icon from a given set of icons to illustrate the item type. For example, the client can use a leaf to represent a pile of leaves that needs to be picked up and can display the leaf at the physical location where the item was identified on a map 132, such as is seen in 132a on map 132. For code violations in code enforcement applications, a sign can be used for signage violations and an electrical icon can be used for post-disaster applications showing downed live electrical wires. If audio or visual information is included in the record, the client instructions can indicate audio or image information by, for example, highlighting the location item with a yellow outline and illuminating the appropriate item on a button bar. Once the map has been populated, map 132 is ready to be given to specialized public infrastructure operators (crews) who can address each item as needed. By way of example and not limitation, map 132 includes seven individual items. Leaf and brush piles are located at 132a, broken street lamps are located at 123b, and discarded appliances are shown at 132c.

The server computer readable instructions, also referred to as the server program or client instructions, can also display items on a map received from multiple portable computing devices. Since a portable computing device's information is received and stored as data on the server, the portable computing device records can be centralized and combined where appropriate. Items can be easily searched by date, time, and portable computing device name. Once the data is retrieved, the records can then be filtered by item type. The client instructions allow the user to view all items identified from all portable computing devices and to create work orders that can be used to delegate remedial tasks and activities associated with each item. Client instructions can sort the item by task type, item type, route and even responsible public infrastructure service provider. When sorted, maps and work orders can be generated as filtered for specific operators and crews so that an efficient system and method of identifying items and scheduling remediation and actions for such items is provided.

The client instructions can also determine the best route for an operator or crew for a specific selection of items. For example, MapPoint, with specific locations placed on a map, can calculate the shortest route to each of the identified items using either the physical latitude or longitude coordinates as waypoints or using the address itself from MapPoint. This information can be used to create work orders that are in order of shortest travel route to further improve efficiencies. Moreover, because the address is often different from the actual latitude and longitude coordinates, the client instructions can draw the map so that the best route is calculated from the actual location coordinates, rather than the addresses found in MapPoint's database.

The client instructions can be useful for other purposes, such as vehicle tracking. If desired by the user, such as a public works department, the client instructions can save a “bread crumb” trail corresponding to the actual route taken by a service vehicle using the system. In this way, a record is made of the vehicle route, speed, and location at any given time. These bread crumbs can be configured so that they have a start and stop time for each day selected. They can also be configured to record a bread crumb mark for any interval between 5 and 60 seconds. These settings tell the computer instructions on the portable computing device when to mark a point.

In one embodiment, map 132 is provided to each crew in hardcopy form. In another embodiment, map 132 can be electronically communicated to one or more portable computing devices associated with the proper vehicles to facilitate quicker response times. As such, map 132 could easily be transferred in electronic format back to original portable computing device 100 or another portable computing device in another crew vehicle 134 through wireless communication with mobile network 126. This can be achieved in one embodiment using XML files to export the data from one device to another.

Although a map only may be sent to work crews in the field, the client instructions also preferably include the ability to create and track work orders associated with one or more items. This is accomplished by including a set of crew information on the server representing workers, worker skills, worker work schedules and worker's routes. If needed, the user can apply filtering criteria to parse the records into suitable groups of items needing further attention by workers. The server then generates a work order for each item based on the crew information. In this way the server creates work orders based on the number of available workers, worker skills, schedules, and routes so as to properly assign each work order to the proper worker.

Once created, the server transmits the work order to the appropriate portable computing devices held by the appropriate workers and/or crews. A worker then views the displayed work order on device 100 and travels to the specific location to complete the work assigned. In one embodiment, device 100 directs the worker back to the specific item using internal mapping software and onboard GPS receiver 108. When work on a specific item and associated work order is completed, the worker will enter the appropriate work order profile in the portable device 100 and mark the work order completed. Completion information is stored in portable device 100 and then transmitted to server 116. When received, server 116 updates the work order for that specific record as completed so that users may be informed.

The user can specify which device to send the work order or proximity locations to via the server. The server will then prepare the data so that the next time the selected portable computing device communicates with the server, the work order and/or proximity data is uploaded to the portable computing device. Once map 132 is received in crew vehicle 134, that crew could immediately address the items, thereby facilitating even quicker response times. The operators of the portable computing device can use the work order data to check off items that were completed. The next time the portable computing device connects to the network, the work order's status will show which items were completed, which were not, and any associated notes that the crew entered while fulfilling the work order.

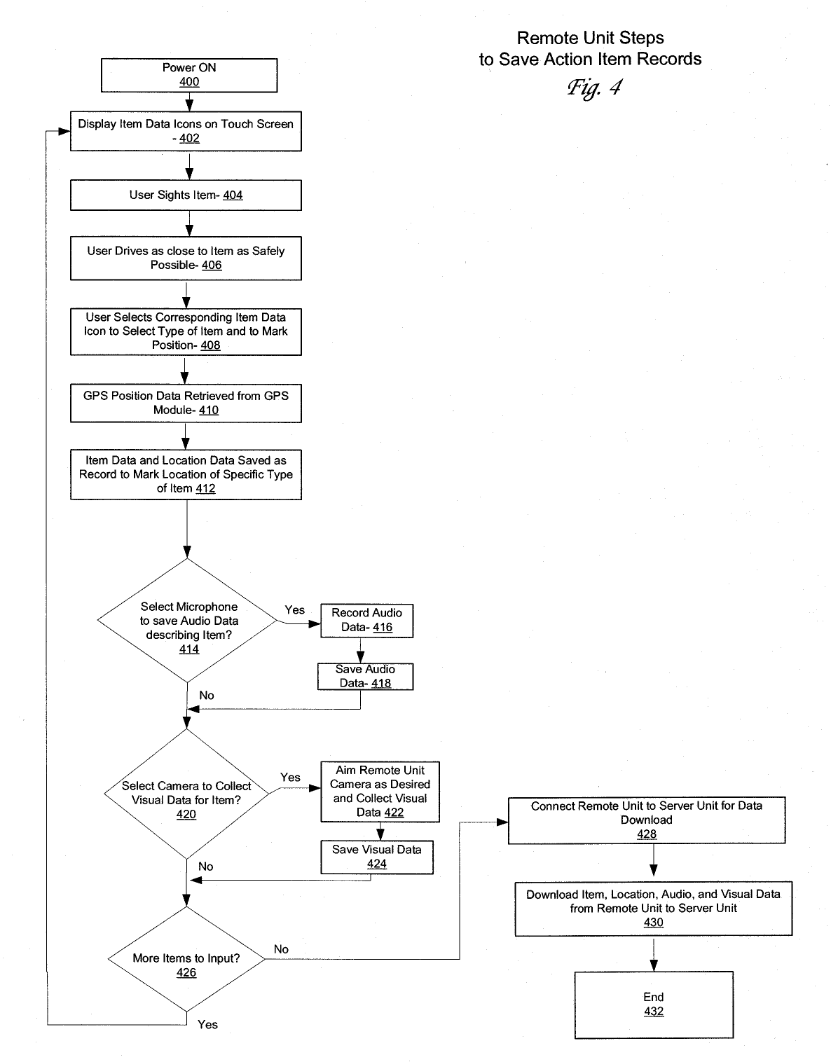

The components of portable computing device 100 and server 116 are perhaps more easily described with reference to FIG. 3. Portable computing device 100 can be a PDA or other handheld computer and can include a variety of components that internally communicate through electronic interfaces. In this embodiment, portable computing device 100 is powered by a rechargeable battery illustrated as power supply 170. In a preferred embodiment, portable computing device 100 is equipped with a touch screen 104 for input. In one embodiment, portable computing device 100 is in communication with a digital camera 112. Similarly, portable computing device 100 may be in communication with an audio recorder 110. In one embodiment, portable computing device 100 is equipped with wireless communications hardware 148 capable of real time communication with the server 116.

Records are stored in remote computer readable medium 106, also known as a portable computer storage media. Once transferred, these records are stored in server computer readable medium 128 as item data 158, location data 156, visual data 154, and audio data 152. It should be understood that location data 156 preferably contains temporal data as well. Using mapping instructions 162, as contained in one aspect of the server program stored in computer readable medium 128, server 116 then converts the location data 156 of each record into a physical address. Mapping instructions 162 then overlays the physical address of each record onto a map record 190. The specific type of item is then overlain on map 190 by instructions 162 using item data 158 to retrieve an icon associated with the specific item type. The icon is then used for graphical display on the map. In the event that there is audio or visual data, audio or visual icons are overlain on map record 190. Mapping instructions 162 store map record 190 to computer readable medium 128. Map record 190 can then be printed using printing means 164 or electronically transferred back to portable computing device 100 or another portable computing device in another service vehicle, such as vehicle 134 shown in FIG. 1.

Referring now to FIG. 4, the typical steps involved in using an embodiment of the invention are described. Portable computing device 100 is powered on at step 400. Computer readable instructions 150 direct portable computing device 100 to display item icons on the portable computing device display 104 at step 402 according to the current profile. Through the input device, the current profile can be changed and is also user-programmable.

In this embodiment, portable computing device 100 is mounted inside of a public works vehicle engaged in a daily work route. As the operator drives around the designated route in vehicle 102, he sights an item needing attention by a public works department at step 404. In step 406, he then places the vehicle 102 as close to the item as safely possible or carries the portable computing device as near the item as possible. Once the portable computing device is properly positioned, at step 408 the user selects a corresponding item icon on screen 104 to input the item type into the portable computing device 100. Remote computer readable instructions 150 retrieve GPS location data from GPS receiver 108 at step 410. Computer readable instructions 150 create a record at step 412 and populate the record fields with information such as item type, position data, time, and date and save the record in remote computer readable medium 106.

If the user wishes to add additional information to be associated with the item, additional information such as audio data and visual data can be stored and associated with the record. If audio data is desired, the user can use microphone 110 at step 414 to record a message at step 416. This audio data is then associated with the record and saved in computer readable medium 106 at step 418.

At step 420, the user has the option of associating visual data with the item. If desired, a visual capturing device such as a digital image or video camera is used to capture visual data in step 422. The visual data is then associated with the record and stored in computer readable medium 106 at step 424.

At step 426, the employee decides whether to continue entering additional items starting again at step 402. The user can also decide to download the saved records to server 116. Step 428 illustrates the user initiating a communications connection between the portable computing device 100 and the server 116. Once a connection is established, at step 430 the item, location, audio, and visual data for each record can be downloaded to server 116. The process ends at step 432.

In one embodiment, the portable computing device communicates with the server in real-time eliminating the need for batch downloads and uploads and providing on demand updates and information retrieval to and from the server.

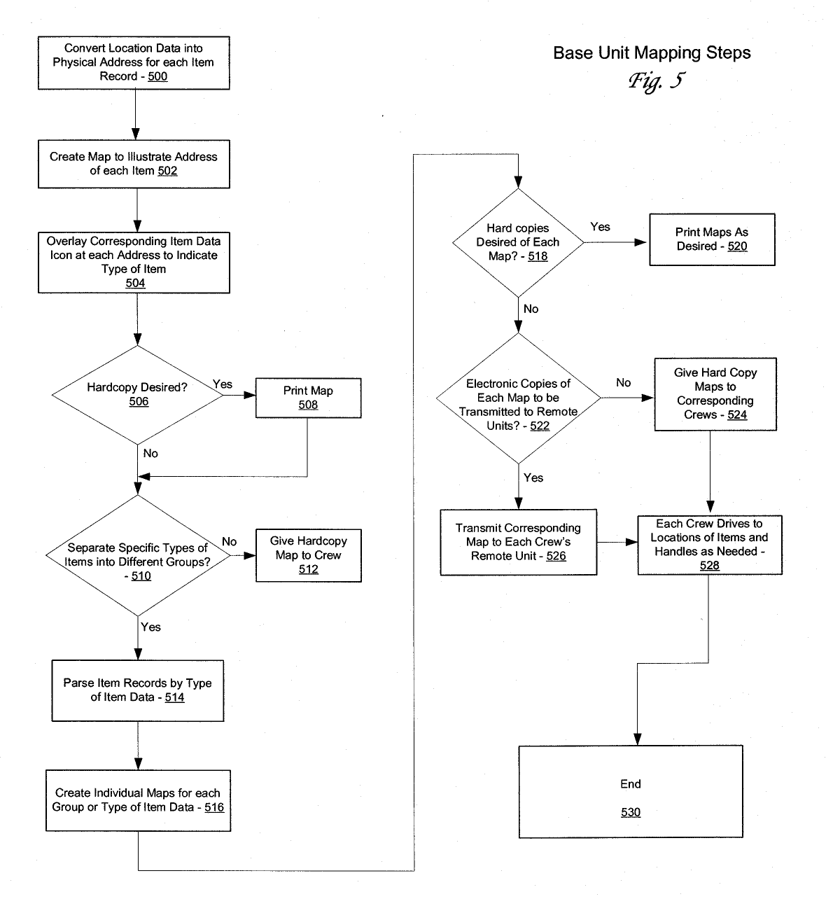

Referring now to FIG. 5, at step 500, the location data 156 portion of each record can be converted into a physical address using mapping instructions 162. At step 502, mapping instructions 162 can create a map 132 to illustrate the address of each item. Those instructions, at step 504, then overlay a corresponding item icon at each address to indicate the type of item located at that address. When the original item was entered by selecting a corresponding item icon at step 308 of FIG. 3, that same icon is preferably used again in the map 132 to indicate the type of item to be later addressed by a public works employee.

In one embodiment, the server computer readable instructions create a map layer having certain aspects based upon the record to be overlaid with a preexisting map. This allows for the present invention to be incorporated with GIS information and displayed with other layers on a map. Once the initial map is created with all items records overlain, the user has the option, at step 506, of printing that map at step 508.

Although a map with multiple types of items is certainly possible, it may be preferable to separate specific types of items into different groups at step 510 using filtering criteria, so that different public works crews can use different maps to address their own specialty items. For example, yard refuse crews traditionally pick up only organic waste such as leaves and brush. It may be preferable then to have those crews use maps that display only items consisting of such organic waste, and thereby illustrating only item data icons such as leaves. If, however, there is only a single crew that is used to address all items, or each crew already understands that it should only address its specific type of item, the user can select No at step 510 and instead give the full map in hardcopy to the crew at step 512.

In one embodiment, computer readable instructions 160 and mapping instructions 162 operate using filtering criteria to separate specific types of items into different groups in order to ultimately create separate maps by item type. In step 514 the computer readable instructions can parse each record by item type. Individual maps for each group or type of object can then be created at step 516.

If the user, for example, a public works department employee, wishes to proceed with hardcopy maps at step 518, those maps are then printed at step 520 as desired. If the public works department chooses not to distribute electronic copies of the maps at step 522, it can simply give hardcopies to corresponding crews at step 524.

In one embodiment, at step 522, maps are transmitted electronically to portable computing devices for attention by appropriate personnel in the field at step 526. The process is completed when each crew then uses the maps at step 528 to handle each item in the field. The process ends at step 530. In another embodiment, instead of maps, work orders are issued in the same manner and the method includes additional steps to track the status of those work orders from inception to completion.

The portable computing device can also use predefined forms for data collection and can have free form text entered by the user. In one embodiment, the portable computing device consists of an off-the-shelf, hand-held Personal Data Assistant (PDA), manufactured by Hewlett-Packard or equivalent, running Microsoft Windows Mobile Operating System version 5 or greater. The unit has geographical positioning system (GPS) functionality, Bluetooth wireless connection, WiFi wireless connection, touch-screen input, a removable SD memory card, usually of 2-gigabyte or greater capacity. The portable computing device can be mounted in a hardened weather resistant case for protection against physical damage, and is installed removably on the inside windshield surface of the refuse-collection or other patrolling vehicle.

Although several embodiments have been described in some detail for purposes of illustration, various modifications may be made without departing from the scope and spirit of the invention. Accordingly, the invention is not limited to the embodiments provided herein. These illustrated examples are offered by way of illustration of the invention's versatility and not meant to limit the invention in any way. The present invention may be embodied in other specific forms without departing from its spirit and essential characteristics. The described embodiments are to be considered in all respects only illustrative and not restrictive. The scope of the invention is, therefore, indicating by the appended claims, rather than by the foregoing description. All changes that come within a meaning and range of equivalency of the claims are embraced within their scope.

What is claimed is:

1. A system for identifying and recording items of interest comprising:
a portable computing device having a GPS receiver, display and portable computer storage media in communications with a server;
a portable device program embodied in said computer storage media of said portable computing device that when executed by said portable computing device performs the steps of displaying item data wherein said item data represents physical items of interest, receiving user input representing that an item of interest has been identified by the user, generating a record representing the item of interest using said user input, retrieving location information and temporal information from said GPS receiver, including said location information and said temporal information in said record, storing said record in said portable computing device; and,
a server program embodied in said server that when executed by said server performs the steps of receiving said record, generating a map displaying an icon representing said item of interest according to said record and transmitting said map display to said portable computing device so that said portable computing device can display said map display allowing the user to view the location of the item of interest and its location.

2. The system of claim 1 including:
a microphone included with said portable computer device; and,
said portable device program performs the steps of receiving audio information from said user representing verbal information about the item of interest and associating said audio information with said record.

3. The system of claim 1 including:
a camera included with said portable computing device; and,
said portable device program performs the steps of receiving visual information from said user representing images of the item of interest and associating said visual information with said record.

4. The system of claim 1 wherein said server program performs the steps of receiving a plurality of records, receiving filtering criteria from said user, generating said map display according to said filtering criteria having a plurality of icons representing a plurality of items of interest so that said map display provides only items of interests according to said filtering criteria.

5. The system of claim 1 wherein said server program performs the steps of receiving a plurality of records, determining a route between said items of interest represented by said icons according to said records, generating said map display according to said having a plurality of icons representing a plurality of items of interest, and indicating the order of travel between said items of interest according to said determined route.

6. The system of claim 1 including:
a set of crew information included on said server representing workers, worker's skills, worker's work schedules and worker's routes;
said server program performs the steps of generating a work order according to said records and said set of crew information, transmitting said work order representing a task to be preformed by a worker to said portable computing device, receiving completion information representing that the worker has satisfied the tasks described in said work order and associating said completion information with said work order; and,
said portable device program includes the steps of receiving said work order, displaying said work order on said portable computing device display, receiving completion information from the user of said portable computing device and transmitting said completion information associated with said work order to said server so that the user of said server is informed that said work order has been completed.

7. The system of claim 1 including:
a set of physical address information stored on said server; and,
said server performs the steps of retrieving physical address information from said location information of said record, matching said location information to a physical address, and transmitting said physical address to said portable computing device.

8. The system of claim 7 wherein said portable computing device program includes the steps of receiving a physical address verification request, transmitting said physical address verification request to said server, receiving said physical address information from said server and displaying said physical address to the user.

9. The system of claim 7 wherein said server performs the steps of retrieving a plurality of physical addresses in proximity to said location information of said record and transmitting said plurality of physical addresses information to said portable computing device.

10. The system of claim 1 including:
a set of profiles included in said portable computing device wherein each profile contains a set of icons representing items of interest; and,
said portable device program includes the steps of retrieving a profile from said set of profiles and retrieving icons from said profile so that said icons can be displayed on said portable computing device.

11. The system of claim 1 including:
a set of location specific information stored on said server indexed by specific location;
said server program performs the steps of receiving location information from said portable computing device, retrieving location specific information according to said location information and transmitting said location specific information to said portable computing device; and,
said portable device program performs the steps of retrieving said location information from said GPS receiver, transmitting said location information to said server, receiving said location specific information from said server and displaying said location information on said display so that the user is provided information associated with the location of the portable computing device.

12. The system of claim 11 wherein said server program performs the steps of receiving said location specific information from a remote user connected to said server through a network using a terminal in a remote location and updating said set of location specific information with said location specific information received from said remote user.

13. The system of claim 1 including:
a set of location specific information stored on said portable computing device; and,
said portable device program performs the steps of retrieving location information from said GPS receiver, retrieving said location specific information, and displaying said location information on said display so that the user is provided information associated with the location of the portable computing device.

14. The system of claim 1 including:
a set of code regulations stored on said portable computing device; and,
said portable device program performs the steps of displaying a list of code regulations on said display, receiving code violation information from the user representing the code regulation selected by the user, associating said code violation information with said location information so that said code violation can be associated with a location.

15. A system for identifying and recording items of interest comprising:
a portable computing device having a GPS receiver, display and a first portable computer storage media;
a set of icon data contained in said first computer storage media having icons representing items of interest;
a portable device program embodied in said first computer storage media of said portable computing device that when executed by said portable computing device performs the steps of displaying icons from said set of icon data representing physical items of interest, receiving user input representing that an item of interest has been identified by the user, generating a record representing the item of interest using said user input, retrieving location information from said GPS receiver, including said location information in said record, retrieving temporal information from said portable computing device, including said temporal information in said record, storing said record in said portable computing device and transmitting said record to a server in communications with said portable computing device;
a set of crew information included on said server representing workers, worker's skills, worker's work schedules and worker's routes;
a server program embodied in a second computer storage media of said server that when executed by said server performs the steps of generating a work order according to said records and said set of crew information, transmitting said work order representing a task to be preformed by a worker to said portable computing device, receiving completion information representing that the worker has satisfied the tasks described in said work order and associating said completion information with said work order; and,
said portable device program further including the steps of receiving said work order, displaying said work order on said portable computing device display, receiving completion information from the user of said portable computing device and transmitting said completion information associated with said work order to said server so that the user of said server is informed that said work order has been completed.

16. The system of claim 15 including:
a microphone included with said portable computer device; and,
said portable device program performs the steps of receiving audio information from said user representing verbal information about the item of interest and associating said audio information with said record.

17. The system of claim 15 including:
a camera included with said portable computing device; and,
said portable device program performs the steps of receiving visual information from said user representing images about the item of interest and associating said visual information with said record.

18. The system of claim 15 wherein said portable device program performs the steps of receiving user input representing a plurality of items of interest, displaying a map representing the location of the items of interest so that said map display provides items of interests and their location to the user.

19. The system of claim 18 wherein said portable computing device performs the steps of determining a route between said plurality of items of interest, displaying a map representing, and indicating the order of travel between said items of interest according to said determined route.

20. The system of claim 15 wherein said portable computing device performs the steps of retrieving physical address information from a server in communication with said portable computing device according to said location information.

21. The system of claim 15 including:
a set of profiles included in said portable computing device wherein each profile contains a set of icons representing items of interest; and,
said portable device program includes the steps of retrieving a profile from said set of profiles and retrieving icons from said profile so that said icons can be displayed on said portable computing device.

22. The system of claim 15 including:
a set of location specific information stored on said portable computing device indexed by specific location;
said portable device program performs the steps of retrieving location information from said GPS receiver, comparing said location information to said set of location specific information to determine when said location information matches the specific location of one of said set of location specific information, and displaying the matching said location specific information on said display so that the user is provided information associated with the location of the portable computing device.

23. The system of claim 15 including:
a set of code regulations stored on said portable computing device; and,
said portable device program performs the steps of displaying a list of code regulations on said display, receiving code violation information from the user representing the code regulation selected by the user, associating said code violation information with said location information to that said code violation can be associated with a location.
